(19) United States
(12) Patent Application Publication
(10) Pub. No.: US 2007/0162508 A1
(43) Pub. Date: Jul. 12, 2007

(54) Updating information in an interlocking trees datastore

(76) Inventors: Jane Campbell Mazzagatti, Blue Bell, PA (US); Jane Van Keuren Claar, Bethlehem, PA (US)

Correspondence Address: UNISYS CORPORATION, UNISYS WAY, MAIL STATION: E8-114, BLUE BELL, PA, 19424, US

(21) Appl. No.: 11/258,296

(22) Filed: Oct. 24, 2005

Related U.S. Application Data
(60) Provisional application No. 60/625,922, filed on Nov. 8, 2004.

(51) Int. Cl. G06F 17/30; G06F 7/00

(52) U.S. Cl. 707/200; 707/101

(57) ABSTRACT

A method for updating a KStore including a K path having a subcomponent node and a root node wherein the subcomponent node has a pointer pointing to a root node and the root node has a pointer pointing to a subcomponent node includes determining a K path representing a sequence to be altered to provide a determined K path and altering at least one of (i) a subcomponent node of the determined K path, or (ii) a root node having a pointer pointing to a subcomponent node of the determined K path. Altering can include maintaining K structure for a history or completely removing a K path. Altering can include altering a subcomponent node of the determined K path. Memory allocated for storing the altered subcomponent node can be deallocated if the node is completely removed.

### BACKGROUND OF THE INVENTION

1. Field of Invention

This invention relates to the field of data storage and, in particular, to the field of interlocking trees datastores.

2. Description of Related Art

The process of detecting and removing and/or correcting a database's dirty data (i.e., data that is incorrect, out-of-date, redundant, incomplete, or formatted incorrectly) is commonly known as “data cleansing,” also referred to as data scrubbing. Methods for the cleansing of data within traditional relational databases are fairly common in the art. For example, U.S. Pat. No. 6,564,215, entitled “Update support in database content management” teaches a method to update data objects that are maintained in data storage external to a database management system (DBMS). A DBMS provides a computer operating environment in which data is typically organized into tables such that the rows and columns of the tables are related to each other. U.S. Pat. No. 6,845,434, entitled “Method for updating parametric data for use in data management system” teaches a similar method whereby there are external data storage devices for storing various parameters. When requirements or parameters change, corresponding parameters stored in the external device can be changed and the changed parameters are written to the transaction data storage device.

U.S. Pat. No. 6,823,359, entitled “System and method for continually updating dynamic data” teaches a similar method used to update dynamic data on a web-page on a real-time basis, without requiring refreshment of the web-page by existing methods or additional software.

U.S. Pat. No. 6,260,042, entitled “Quick difference and update for tree structure data,” teaches an efficient mechanism for the differentiation and update of data structured in tree format. The invention has particular application to version management of tree structured data but the tree differentiation process according to the invention can differentiate any two trees, regardless of whether they are successive versions or not.

There are several limitations with the above methods of data cleansing. While the foregoing examples teach methods for updating and/or correcting information in many types of data bases, they do not teach methods for modifying, updating and correcting incorrect or outdated information that is found in interlocking trees datastores.

All references cited herein are incorporated herein by reference in their entireties.

### BRIEF SUMMARY OF THE INVENTION

A method for updating a KStore including at least one K path having at least one subcomponent node and at least one root node the at least one subcomponent node having a subcomponent node pointer pointing to a root node of the KStore and the at least one root node having a root node pointer pointing to a subcomponent node of the KStore includes determining a K path representing a sequence to be altered to provide a determined K path and altering at least one of (i) a subcomponent node of the determined K path, or (ii) a root node having a root node pointer pointing to a subcomponent node of the determined K path. The altering can include deleting. The deleting can include altering a subcomponent node of the determined K path to provide an altered subcomponent node. Memory is allocated to the altered node for storing the altered node and the memory allocated for storing the altered node can be deallocated. A selected node pointing to the altered node is provided with a node count and the node count is changed to provide an altered node count. The selected node is provided with memory allocated for storing the selected node and the altered node count is compared with a predetermined value. The memory of the selected node is deallocated in accordance with the comparing of the selected node count.

An altered subcomponent node is provided with a bidirectional Result link and the bidirectional Result link is altered to provide an altered bidirectional Result link. The altered bidirectional Result link links the altered subcomponent node with a further selected node and an asResult pointer of the selected root node is altered. A pointer to the altered subcomponent node within the altered bidirectional Result link is maintained to provide a maintained altered subcomponent node pointer in the asResult list. A history is determined in accordance with the maintained Result pointer.

The altered subcomponent node is provided with a subcomponent node count and the subcomponent node count is altered to provide an altered subcomponent node count. The subcomponent node count is altered in accordance with an intensity value to provide the altered subcomponent node count. A history may be determined in accordance with the altered subcomponent node count. A determination is made whether the altered subcomponent node count is below a predetermined value to provide an altered node count determination. The altered subcomponent node may be provided with memory allocated for storing the altered subcomponent node which is deallocated in accordance with the altered node count determination. The subcomponent node count is decremented in accordance with the intensity value. The intensity value can be the value one.

The sequence to be altered is obtained, the sequence to be altered is particlized to provide a particlized sequence and the particlized sequence is used to determine a K location. The K path is determined in accordance with the particlized sequence. The KStore can represent a plurality of paths each having a path identification number and the K path may be determined in accordance with a selected path identification number. A search value is obtained and the K path is determined in accordance with the search value. The K represents a plurality of paths each having at least one root node wherein the search value within a specified root node is determined to provide a root node specific search determination and the K path is determined in accordance with the root node specific search determination. The specified root node has at least one valid associated value and at least one invalid associated value and the search value further can be the at least one invalid associated value of the specified root node. The at least one node is provided with at least one bidirectional link and the determining of the K path in accordance with the K location includes traversing the KStore in accordance with the at least one bidirectional link. The bidirectional link may include a bidirectional Result link and the traversing of the KStore is performed in accordance with the bidirectional Result link. The bidirectional link may be a bidirectional Case link and can include traversing the K in accordance with the bidirectional Case link. The KStore represents a plurality of paths each path of the plurality of paths may have a path identification number and the K path is determined in accordance with a selected path number.

The present invention overcomes the inherent limitations associated with the prior art of data cleansing within traditional relational databases by providing a method that is able to update data in KStore interlocking trees datastores. The system and method of the invention can create and use interlocking trees datastores and various features of interlocking trees datastores. The instantiation of the interlocking trees datastores is referred to as a “KStore” or “K.” In particular, these structures and methods are described in co pending patent applications U.S. Ser. Nos. 10/385,421, (published as US 20040181547 A1) and 10/666,382, both by Jane Mazzagatti.

Additionally, a system in which such interlocking trees datastores could be used more effectively is taught in U.S. Ser. No. 10/879,329 also by Jane Mazzagatti. While the system and method described herein relate with particularity to interlocking trees datastore such as the interlocking trees datastores described in the above-referenced patent applications, it should be readily apparent that the system and methods described herein may also be applicable to any KStore.

The invention described herein below relates to interlocking trees datastores of a structure described in prior patent applications and can be readily used by and adapted to devices described in patent applications U.S. Ser. No. 10/759,466, (now published as US 20050165749) entitled “Saving and Restoring an Interlocking Trees Datastore” and U.S. patent Ser. No. 10/879,329, entitled “Functional Operations for Accessing and/or Building Interlocking Trees Datastores to Enable Their use with Application Software,” which themselves are for use with such interlocking trees datastores. Particularly, the present invention provides a way to manipulate, that is, change, data in a way that was previously impossible in the interlocking trees datastore.

Generally, the KStore interlocking trees datastore is typically built into a structure within the memory of a computer system or computer systems, using a resource called a KStore Engine, which has a small set of rules it applies to data that has been particlized for it and sent to it, in order to support the K Engine task of recording the particlized data as events in the KStore. The KStore itself can be accessed to answer queries about the data, preferably using resources called API Utilities. This is described in detail in the above referenced patent documents.

One problem with data however is that sometimes it is not submitted in final form, or sometimes parts of it must be removed, changed or corrected. There are numerous ways to do this. For example, the data can be removed by recording new data as additional events and then tying these new events to the already stored events in some complex way so that properly structured queries would see both the old data and the new, repaired data when using the KStore with this corrected data in it.

However, such schemes are likely to leave much to be desired in the way of simplicity of code, ease of use, and ready adaptability to numerous real world situations. A simple example might be that of a financial transaction KStore, in which a bad record is created by a typographic error in data entry the day before. A user may want to correct such an error, perhaps without a trail, assuming the user has appropriate authorization. Another example would be where misspellings of words get recorded with the result that these records with the misspelled words should be found in a search or a query of the KStore in which they appear but are not.

Additional situations arise in which dropped characters, bad input and the like are corrected, typically to put a database on better relations with reality. In using the present invention, the object of changing or updating a KStore is to put the KStore into better relation with reality, something that was not possible prior to the invention described herein below.

There are many ways in which data changing operations can be initiated. Altering a KStore structure after an initial experience has been recorded presents unique issues. The issues are difficult to resolve because of the intricate relational connections between nodes within the KStore structure that represent knowledge about the experience. This knowledge is at risk if the KStore structure is altered. The change may involve breaking and restoring connections as well as possibly de-allocating and re-allocating new structure (i.e., nodes).

Accordingly, in the use of the KStore structure, a need is apparent to produce a methodology for safely removing or correcting information within a KStore while leaving the structure fundamentally intact.

### BRIEF DESCRIPTION OF SEVERAL VIEWS OF THE DRAWINGS

For the purpose of illustrating the invention, there is shown in the drawings exemplary constructions of the invention; however, the invention is not limited to the specific methods and instrumentalities disclosed. The invention will be described in conjunction with the following drawings in which like reference numerals designate like elements and wherein:

FIG. 1 is a block diagram representation of a KStore environment in which the data modification system of the present invention may be implemented.

FIG. 2 is an exemplary node within a KStore containing a count field.

FIG. 3 is a table of records for sales activities from a fictional organization useful for heuristic purposes.

FIG. 4 is an exemplary KStore node diagram based on the sales records in FIG. 3.

FIGS. 5A-D are exemplary KStore node diagrams depicting alterations of a sequence.

FIGS. 6A and 6B are node diagrams depicting datastore structure representing “SOLE” being changed to datastore structure representing “SOLD.”

FIG. 7 shows a datastore with structure that has been changed from representing “SOLD” to structure representing “BOUGHT” for all instances “SOLD” within the K.

FIG. 8 is an exemplary KStore node diagram depicting the addition of updated events following the changing of structure representing the variable “PA” to structure representing the variable “NJ.”

### DETAILED DESCRIPTION OF THE INVENTION

Processes and systems are devised for removing, correcting, modifying, or replacing events that are recorded in an interlocking trees datastore. As with any data structure, it may become necessary to remove or in some way modify the information contained within a KStore. In some embodiments a history of the removal or other type of modification can be maintained. In other embodiments a history may not be maintained. The determination that a change is required may be accomplished using any of the examination techniques well understood by those skilled in the art. In such procedures an administrator, authorized user, or some automated process may determine that there is information recorded within the K structure that is incorrect, out-dated, or requires changes for other reasons.

Any such operations performed on an interlocking trees datastore can be broadly referred to as an alteration of the interlocking trees datastore. The alteration of an interlocking trees datastore may include such operations as deleting, adding, repairing or modifying K paths, deleting, adding, repairing or modifying a portion of a K path, or deleting, adding, repairing or modifying any potion of a KStore in any way. When performing any alteration within a KStore a history of a deleted, added, repaired or modified path or portion thereof or any other altered element of the KStore can be maintained. In one preferred embodiment, a history of any alteration of the KStore can be provided. An alteration wherein no history is maintained can be referred to as a complete removal.

In order to perform an alteration, such as the foregoing alterations a sequence to be altered may be used to query the K. The sequence can be a sequence representing of any number of K locations and can identify a portion of any K path or an entire K path. Repairs can then be made to the K paths in which the alterations occur. Although automatic processes may be used to locate the sequence, in a preferred embodiment human review of the data may be used to determine that information within the structure requires a change. Human intervention or review might be encouraged with the added use of triggers or other methods possibly located in the Learn Engine that may compile putative errors or notifications for examination. Programmatic triggers and associated processes may be developed to automatically correct certain common error types, if desired.

The need to alter a KStore structure could be the result of an actual change to/in an event or the correction of an error in input. In one case, modifications may be directed to modifying a sequence forming a complete K path. Partial corrections of sequences or K paths are also possible and methodology to accomplish both is described herein. Within a field record universe, the sequences may represent records or relevant parts of a record such as a word, phrase, column name or field value. While such a field record universe is referred to herein for exemplary purposes it will be understood that the present invention can be applied to any type of data that can be stored in an interlocking trees datastore as set forth in more detail in the incorporated applications. For example, in an image data universe, a sequence could be a set of pixels, a video display row of pixels, a title, or other variables depending on how the data is organized.

There are a number of ways to alter information. One way is by removing an existing sequence and, for an update operation, learning a new sequence. Another is changing existing nodes and monads by altering the bi-directional node pointers when required. The bi-directional node pointers can include bi-directional Result pointers and bidirectional Case pointers. Generally, the altering of sequences can be accomplished by:

Removing existing sequences and learning updated sequences

Rearranging pointers

Combination of above

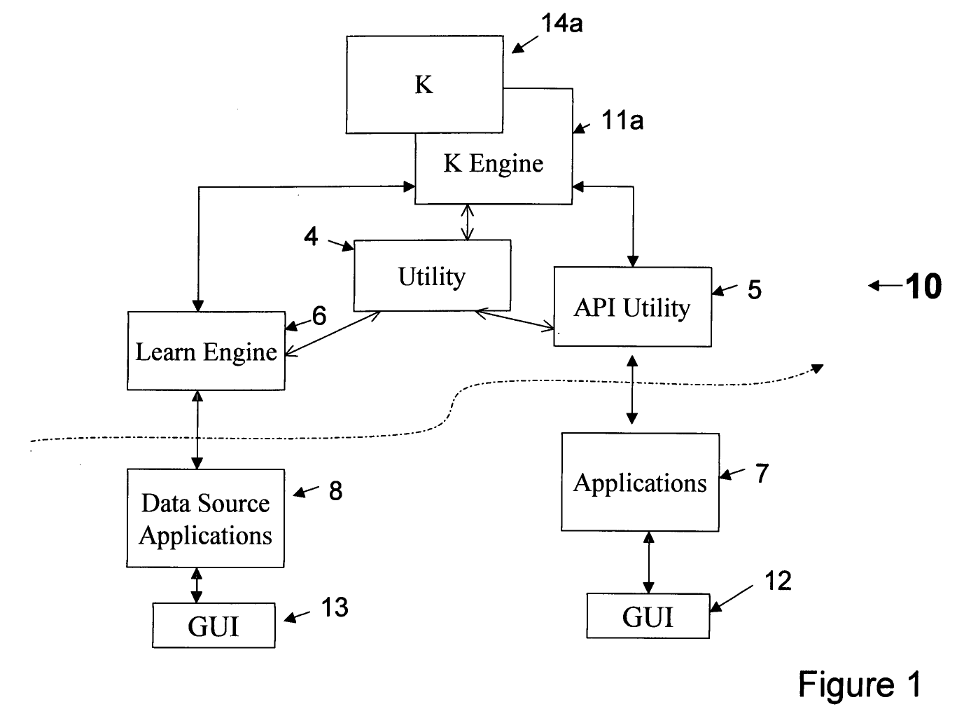

Referring now to FIG. 1, there is shown a preferred embodiment KStore environment 10 suitable for practicing the system and method of the present invention. The K 14a within the KStore environment 10 is accessed by the rest of the KStore environment 10 by way of a KStore Engine 11a. In particular the K Engine 11a can communicate with a learn engine 6 using data source applications 8 and an API Utility 5.

A preferred embodiment of this method provides a count field within the K nodes of the K 14a. While the count fields have been discussed in U.S. patent Ser. No. 10/666,382 it may be helpful to review them here. As has been taught in other patents, the K nodes of the interlocking trees data store may include additional fields representing information associated with the K nodes. Note however that in some preferred embodiments, data is stored only in elemental root nodes. Usually additional fields (if any) may be used to store a count, or perhaps a node type indicator, if desired.

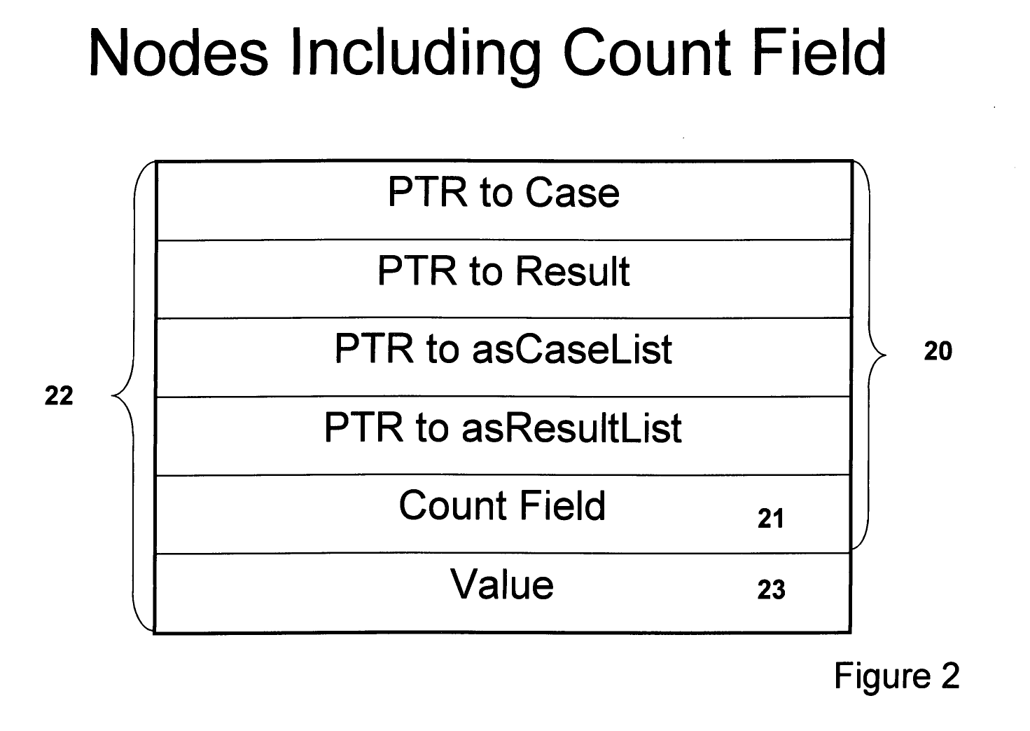

Exemplary K nodes 20 and 22 are shown in FIG. 2. These K nodes 20 and 22 may include a count field 21 as described above, which with other additional fields may have many uses and the K nodes such as K node 20 and 22 need not be limited to one additional field. Typically however, the additional field contains a count rather than a string, and there can be more than one additional field. The number and nature of the additional fields can vary depending on the nature of the KStore being built.

The count field 21 can be initialized to any value depending on the requirements of the system. In one preferred embodiment the count can be initialized to one and incremented with an intensity variable. However, the value of the intensity variable, or the intensity, is not necessarily one and can vary with conditions and time when the count field 21 is referenced. By making this term so broad, the intensity variable populated count field 21 can be used for applying the inventive interlocking trees structure of the K 14a to processes dealing with forgetting erroneous recorded data, recording which entity is doing an inquiry, recording the type of inquiry being used, and other processes of interest which may be derived when using the data.

A simple example form of an intensity variable would be a single ordinal field value, such as ‘1’ to be used to increment or decrement count fields 21 to record the number of times that a node has been accessed or traversed. Further, the value of the intensity variable may change at different rates and in different directions for different functions. For example, the intensity can have a value +1 each time a query traverses a node, and a value of −100 if a KStore path containing a particular node (or a particular sequence of nodes) is deemed to be a mistake. Additionally, a sequence can be determined to have been a mistake such as a misspelling, or in the case of where a sensor finds an area containing a dangerous chemical, or if a human child simulator “touches” and “burns itself” on a hot stove in a simulation.

Thus, in one embodiment, the count field 21 may be incremented when new data is being incorporated into the interlocking trees data store but incrementing the count field 21 may be omitted when the interlocking trees data store is being queried yielding a bigger value for new data and no change for inquiries. Accordingly, this intensity variable may be dynamically chosen for its suitability to the problem being addressed using the KStore 14a.

Additionally it should be recognized that if a count field 21 exists in a node 20, 22 and corresponds to the frequency and intensity of the nodes 20, 22 any of those nodes can be eliminated if they have a zero value in the count field 21. This elimination of null value nodes may also be used for elemental root nodes with count fields 21 of zero value if it is determined that the elemental root nodes are not necessary for the use to which any likely KStore would be put. Furthermore, even nodes with low valued counts could be eliminated if desired; they do not have to be equivalent to a zero value. This could happen, for example, if a KStore developer has reserved a number of particles but finds that they are not useful once more data is gathered. Also, in applications where there can be subtractions from the values in a count field 21, such K nodes may also be eliminated since they could represent errors or misspellings or the like. In some situations, the elimination of any K nodes may not be permitted. Under these circumstances even K nodes with a null value in the count field 21 can be saved in order to maintain the history of the KStore 14a.

Thus, a history of the alterations to a KStore can be maintained with the KStore. Additionally, it will be understood that such a history need not be stored within the nodes of a KStore as described in the embodiment above, or even within the KStore itself. The history of the alterations of the KStore can be stored in a log, in another KStore or any other data structure or storage device known to those skilled in the art.

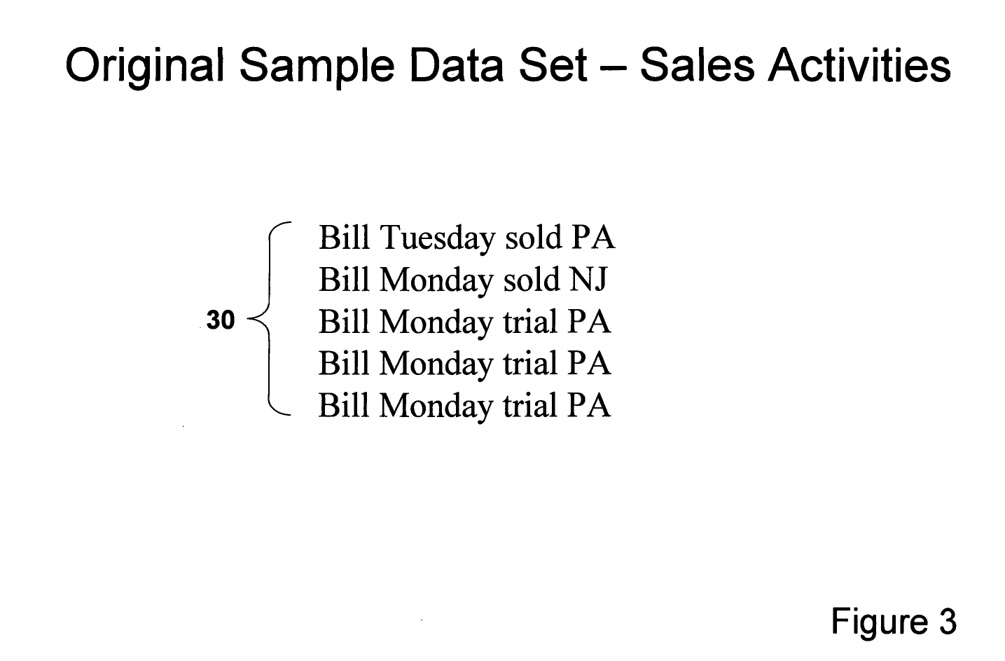

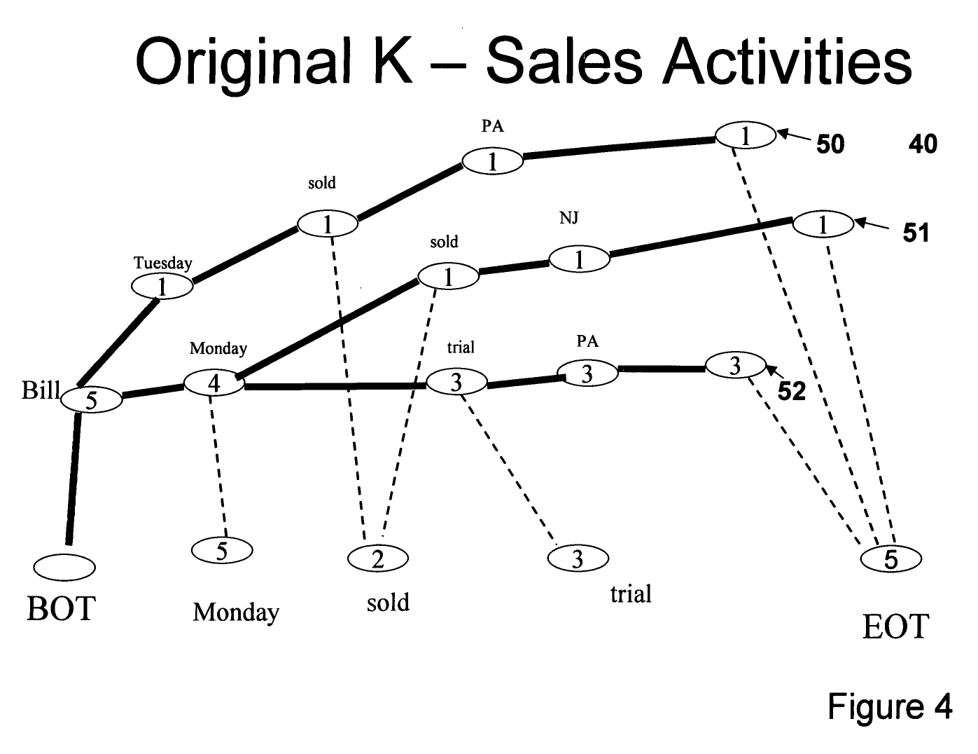

A set of five fictional records 30, shown in FIG. 3, is used to help illustrate some preferred embodiments of methods for updating information in a KStore such as the KStore 14a. The fictional records 30 identify sales of a period of time for a furniture store salesman named Bill. FIG. 4 is a KStore node diagram 40, illustrating how nodes might be established in a KStore 14a in the ordinary course of feeding the particlize data from FIG. 3 into the K Engine 11a as described in earlier patent documents referenced and incorporated herein above.

Removing Existing Sequences and Learning Updated Sequences

One method for removing existing sequences and learning updated sequences that can be used to modify a sequence in the K 14a that is incorrect or is no longer desired is as follows. This method can be accomplished by removing an entire sequence or path from the K 14a. A new sequence can be learned to take its place in K 14a. A preferred embodiment of such a method can consist of three general steps:

Locating a KStore path or portion of a path to be altered

Removing the located K path

Learning a new sequence containing updated data

Determining the K Path to be Changed or Removed

In one preferred embodiment of the invention, the particle sequence within a KStore 14a to be changed is identified and located by particlizing the sequence to be altered and processing the sequence through the KEngine 11a, wherein the alteration can be an updating, a removal leaving empty nodes, a complete removal or any other kind of change. This process includes traversing the K 14a in a manner understood by those skilled in the art. The K location pointer that is returned from the KEngine 11a may be used to identify the determined K path. The alteration can include altering a pointer of a K node, altering a count of a K node and/or a combination of altering a pointer and altering a count of a K node. For purpose of altering a determined path, the determined path can include a BOT node, an EOT node, any subcomponent node or nodes there between and any elemental root node or root nodes (including any such nodes linked to a different level of a multi level datastore).

It should be noted, however, that the K path to be altered, can be located in any manner known to those skilled in the art that is effective for locating sequences of K nodes within a KStore 14a. For example, in some applications records received for representation in the KStore 14a are provided with record identification numbers. Thus, it may be possible to locate a record to be removed or changed according to its identification member. Furthermore, if a record with an identification number that was previously received is again received it may be determined that the previously received record could be located using the identification number. The previously received record could then be changed according to the new record, depending on the application.

Furthermore, a record could be located for alteration according to a determination that an invalid value is found in one of its fields. In yet another exemplary embodiment of the invention, records within the K 14a to be changed can be located by locating a record having a specified value therein. Additionally, all of the records having the specified variable therein can be located. Furthermore, all the records having the specified value in a specified field of a record may be altered. When the K 14a includes data other than field record data, for example, image data, audio data or amino acid data any manner known to those skilled in the appropriate art for searching such data for information to be altered can be used.

Removing a Located K Path

Once a sequence is identified by any appropriate method or criteria, the sequence can be changed as required by the application. As the previous section indicates, there are numerous methods for locating a path that may be employed to accomplish this task. A few of the more common methods for performing these operations are described in the above referenced patent applications, although one of skill in the art may determine other methods depending upon the specific requirements of the KStore 14a.

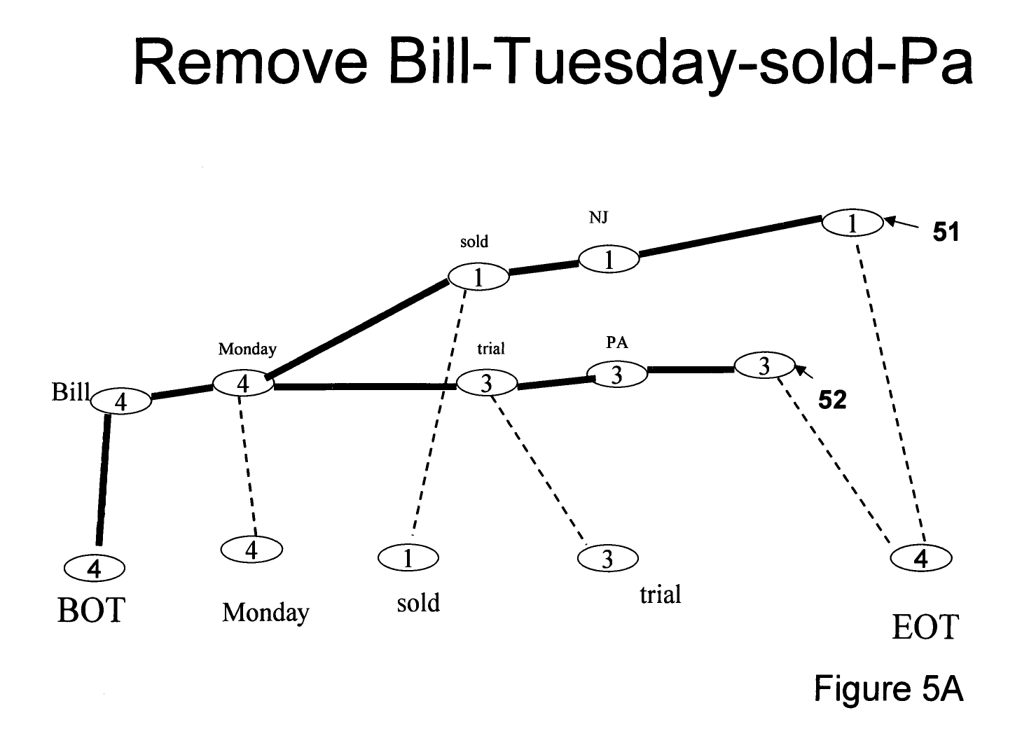

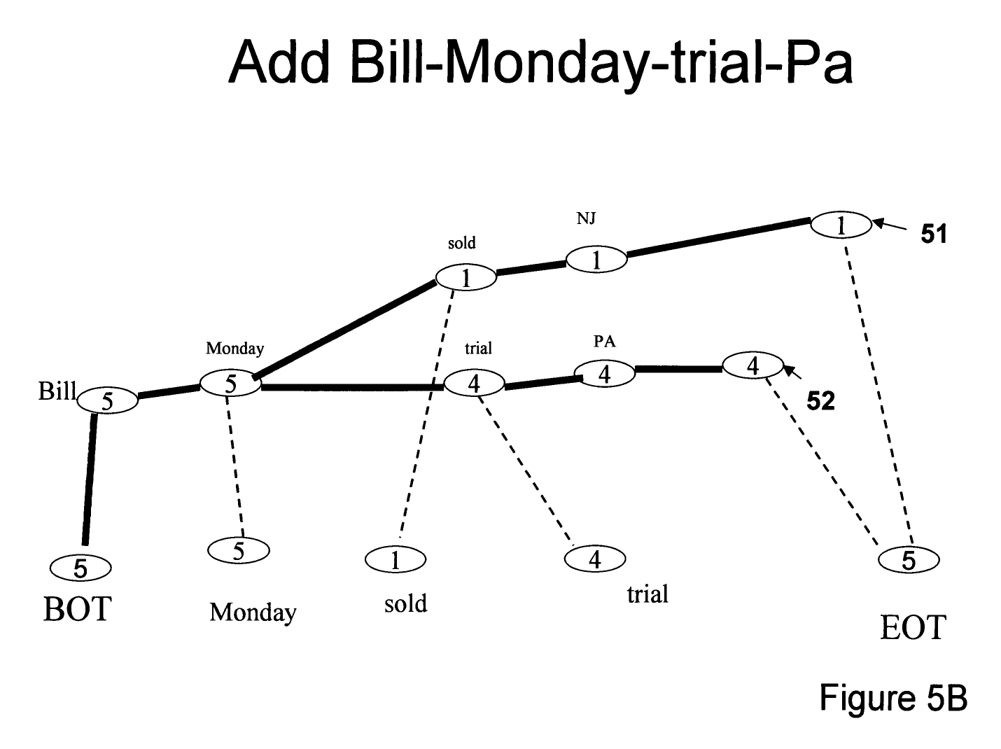

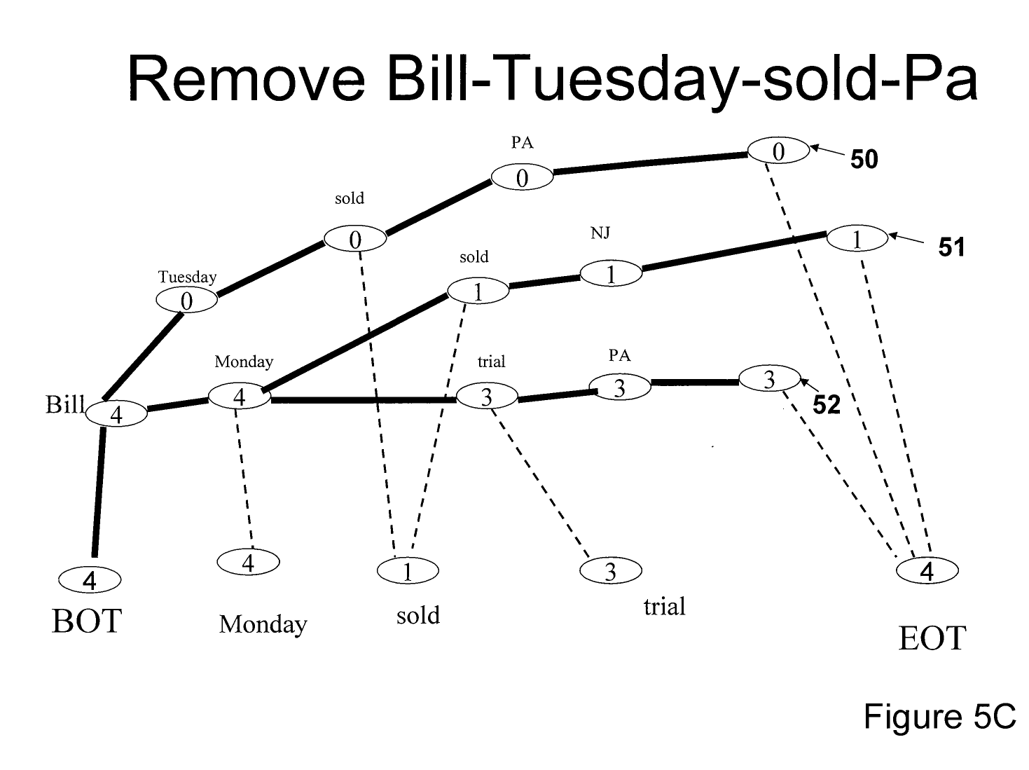

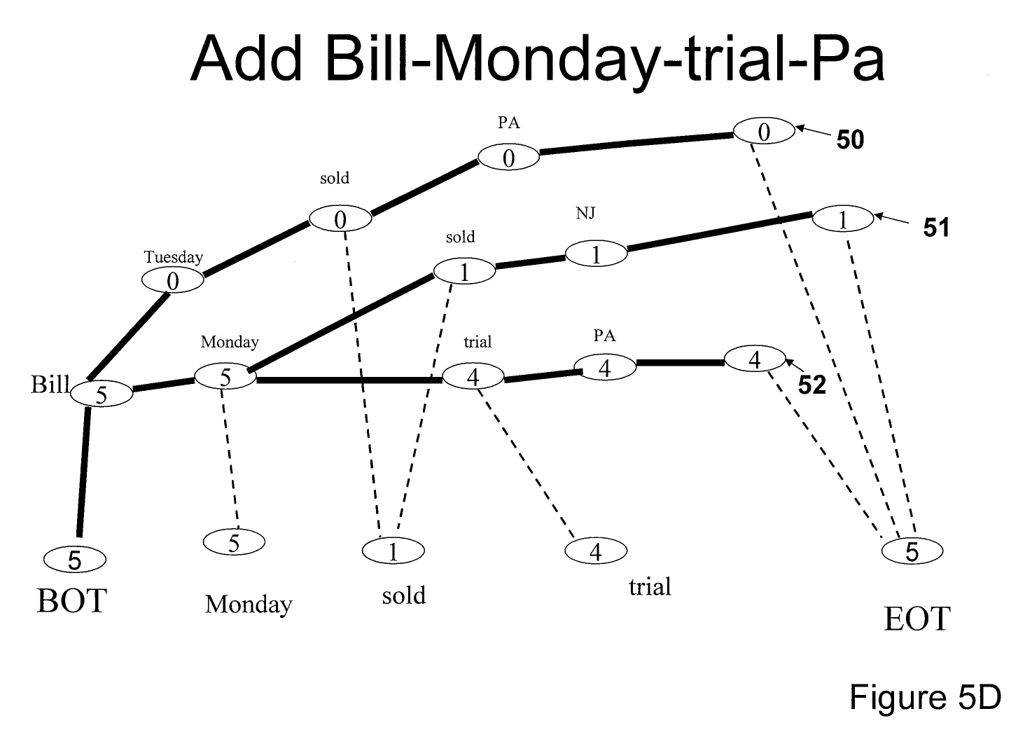

As shown in the embodiment of FIG. 5A, the K nodes along a specified sequence or K path such as the K path 50 can be completely removed by deallocating the memory associated with the node. Additionally, the asResult lists and the asCase lists of any nodes in the K path 50 can be altered. These nodes can be altered to reflect the fact that their asResult lists or asCase lists no longer contain pointers to the nodes removed from the K path 50. If the K nodes involved have counts the counts can also be altered.

Such an alteration of nodes in a K path can be referred to as a physical removal or complete removal from the K since there may no longer be any history of the path in the K. However, a record of the path may still exist elsewhere, for example, in a log or other location outside of the K. When such a complete removal is performed the memory allocated for the storage of the pointers and counts of the K nodes within the K path 50 that are no longer required can be deallocated.

FIG. 5C shows a KStore node diagram in which the first record of the table shown in FIG. 3, and represented as the K path 50, is altered. However, the path 50 in not completely removed as shown in the embodiment of FIG. 5A. In this embodiment of the invention, the count field 21 of each node in the K path 50 is decremented thereby indicating that the record is changed. In this case some of the nodes are decremented to 0 since only one record was represented by the path 50.

However, the structure of the K path 50 is maintained in FIG. 5C even though some of the count fields 21 of the K nodes within the K path 50 are zeroed. This kind of logical removal of the nodes while maintaining the K path structure permits the K 14a to maintain a history of the changes that take place.

In a preferred embodiment in which the nodes contain a count field 21, an identified K path is traversed and the count field 21 for each node in the K path is altered according to a desired intensity. As previously described, if a count field 21 decrements to zero (or low count), and there is an indication that the node may be deleted, the node and related pointers can be deleted from the datastore structure. In a field record universe with unique records, the count for each record sequence is 1, so there will be nodes along the identified K path that will be reduced to 0 by this action.

Once zero (or low) count nodes are found, they may be removed immediately. Alternatively, they may be phased out of the KStore structure by an independent or separate maintenance algorithm, possibly by referencing, for example, a time stamp or other device for indicating time. In one alternate embodiment such nodes may be maintained for the purpose of maintaining a history of the structures represented in the K 14a. They can thus be treated as deleted even though they are not completely removed and they remain in the datastore with zero counts. They can also be phased out periodically. Furthermore, they can be removed in response to certain conditions, triggers, user input or other indicators. Additional fields can be added to the K nodes of the K 14a in order to facilitate this if that is desirable.

Another alternative to completely deleting the K nodes is maintaining the removed nodes in the structure and identifying the K nodes in some manner as having been changed or deleted. For K structures in which the K nodes contain a count field 21, the count field 21 may be used to indicate that a sequence had been changed. The nodes with 0 (or low) count values or predetermined values defined to indicating a change can be left in the KStore structure as a reference that the event represented by the nodes had occurred and had been changed.

A determination to maintain nodes with a low count can be implemented by use of a switch, a separate procedure call, or any other method that may be desirable to indicate that nodes having a low count or a predetermined value should be maintained. For instance, it may be important to know that the word “TRIAL” has been misspelled. It may also be important to know how many times “TRIAL” has been spelled incorrectly. If a determination is made that the count field 21 is set, for example, to zero, it is known that there was an incorrect spelling and that it was deleted. However, it would not be known how many times the particular misspelling had occurred. A possible solution is to use a negative count to indicate the number of times the incorrect value is seen. For example, −5 in the end product node for the misspelled word “TRIL” could indicate that the word was misspelled in this manner five times. In another embodiment, an additional field can be provided for each node just to keep the count for deletions.

A method that applies equally to K structures with or without count fields 21 is the addition of nodes to the sequence to indicate that it had been changed or “removed”. This additional node may also indicate the number of times the sequence had been changed or have additional information concerning the change, perhaps a date or time stamp. Another method may be to connect the sequence to an “error” or “deleted” EOT node.

Learning New Sequence Containing the Updated Data

If this is an update operation, then the updated sequence may be incorporated into the K utilizing any learn method available. For an update operation, one can go about incorporating the updated sequence into K by using the methods generally provided through the Learn Engine for learning new sequences. Such incorporation may be done as described in the patents cited and incorporated by reference above. Thus, an update can generally be thought of as receiving input, adjusting it, particlizing it, and giving it to a KStore Engine to be recorded as a sequence of events in K. As mentioned above, altering a sequence could be done for a partial sequence or for altering just one or more branches of a KStore path.

Depending upon circumstances, it may be more efficient to learn the altered sequence prior to removing the existing sequence. This is particularly true if the process involves the destruction of nodes with low count. Processing the new sequence prior to removing the existing sequence may save the destruction and recreation of nodes that may be reused by the altered sequence.

FIG. 5B shows an alteration of the structure within the K 14a for representing the first record of FIG. 3 from “Bill Tuesday sold PA” path 50, to “Bill Monday trial PA” 52. In this embodiment the K path 50 can be completely removed as described with respect to FIG. 5A, and thus no history of the alteration of path 50 is maintained as shown in FIG. 5B. Additionally, the counts of the nodes on the path 52 can be incremented to reflect the new record “Bill Monday trial PA” represented by the path 52.

Thus, the node diagram in FIG. 5B shows the datastore structure as it might appear when the first record of FIG. 3 is changed to include new data or updated data. Specifically, the day of the week field is changed from “TUESDAY” to “MONDAY” and the transaction field is changed from “SOLD” to “TRIAL.” The values in the count fields 21 of the K path 52 reflect the change when FIG. 4 is compared with FIG. 5B as follows. The count field 21 of the end product node of the K path 52 has been incremented from 3 to 4. Additionally, the count fields 21 of the subcomponent nodes and the elemental root nodes within the K path 52 are also incremented by the intensity 1.

In the same manner, FIG. 5D shows the alteration represented in FIG. 5B wherein the structure and history of the path 50 is maintained when the updated record is learned.

Rearranging Pointers

In another embodiment, it may be possible to implement an alteration by changing pointer values alone. Small sections or even just a single subcomponent node or root node could be modified to complete an alteration. In this case the required nodes already exist and the Case and Result bidirectional links and the count fields 21, if present, are altered as necessary.

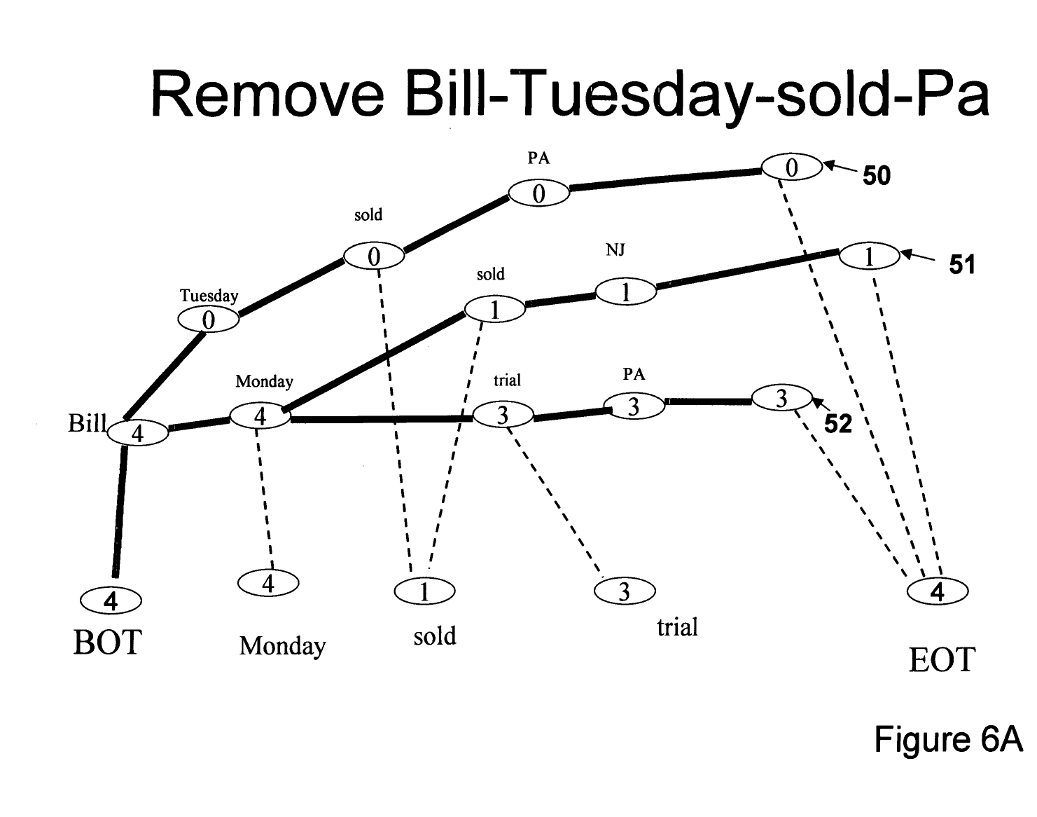

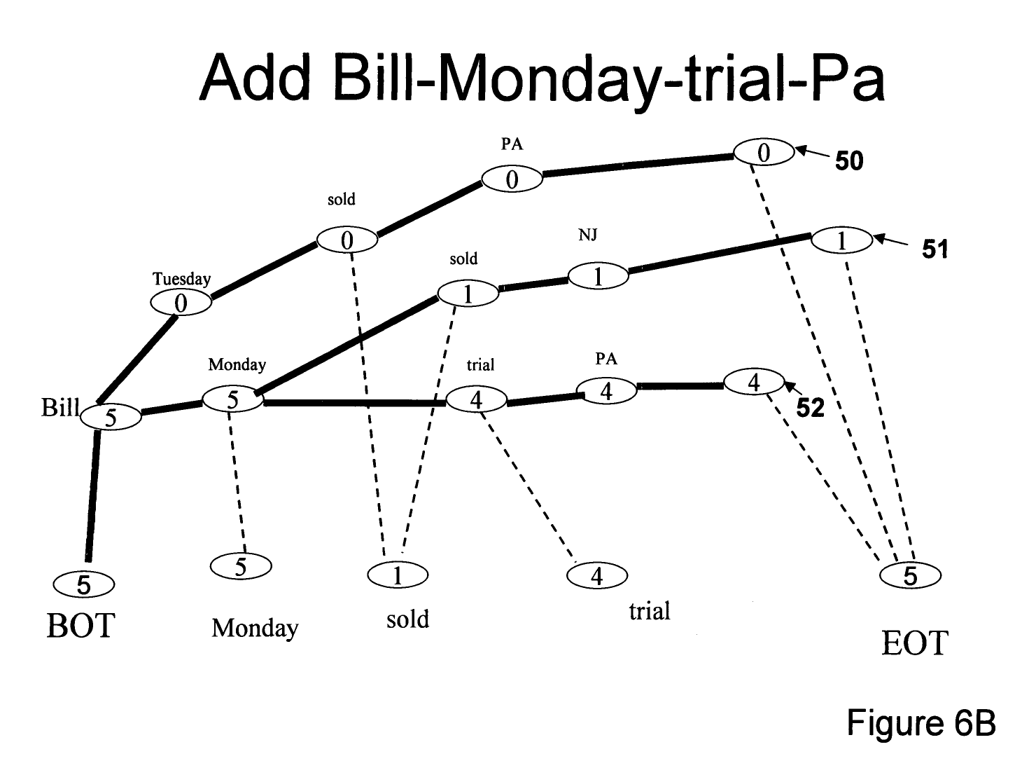

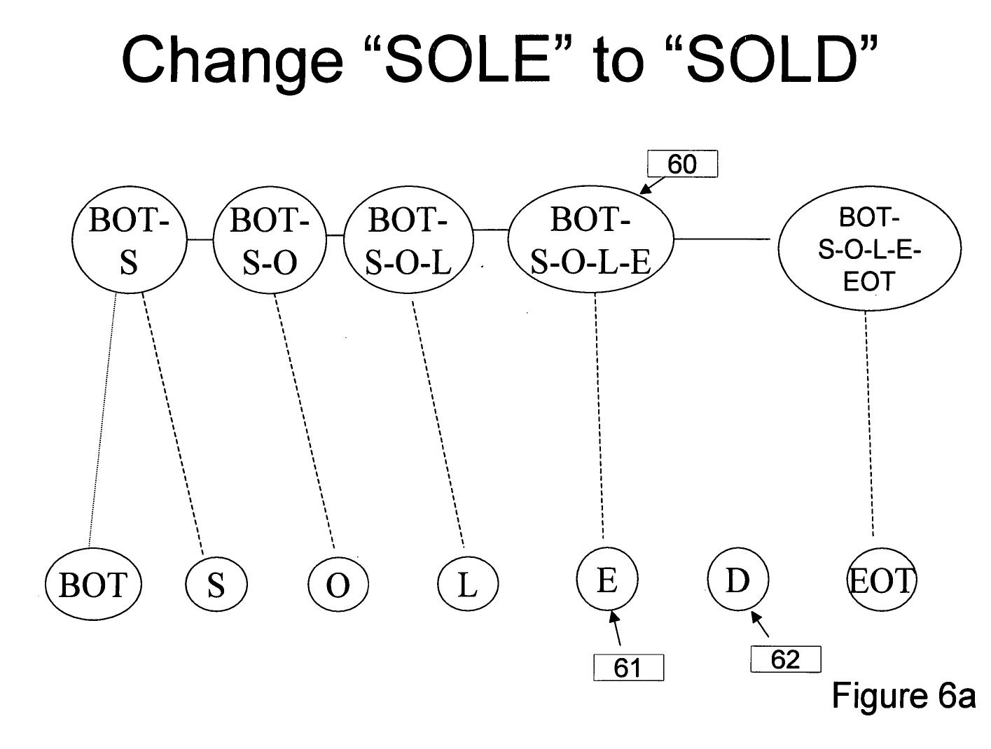

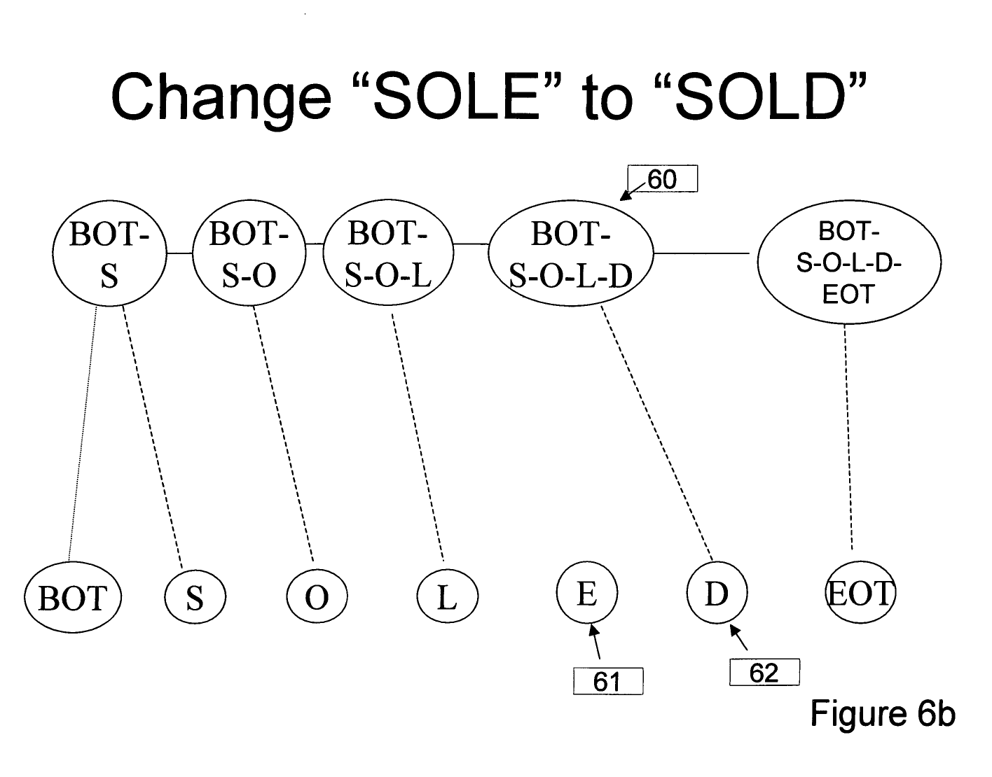

For example, in FIGS. 6A and 6B assume instances of “SOLE” occurring in the K 14a are all changed to “SOLD.” Instead of deleting “SOLE” and then learning “SOLD” it is possible to change the Result link of the node BOT-S-O-L-E, 60 in FIG. 6A from pointing to the E elemental root node 61 to pointing to the D elemental root node 62. Node 60 could then be removed from the asResult list in the E elemental root node 61 and the count field 21 of node 61 reduced by 1. The asResult list in the D elemental root node 62 may then be updated to include the node 60 and the count field 21 if present of node 62 can be increased by 1. The final result of the changes may be seen in FIG. 6B. Note that only information within the nodes 61, 62 and 63 has been updated. It should also be noted that the foregoing changes can be performed in any order.

Combined Approach

Another method is also described that uses a combined approach to solve a similar set of problems. This method might involve removing a sequence or partial sequence from the K 14a and adding a replacement sequence and then rearranging the node pointers to connect the corrected sequence to the unchanged portion of the K path. Another alternate embodiment might involve altering pointers from one existing sequence to another existing sequence and then adding new structure as necessary. The changes may be performed at any level of the KStore.

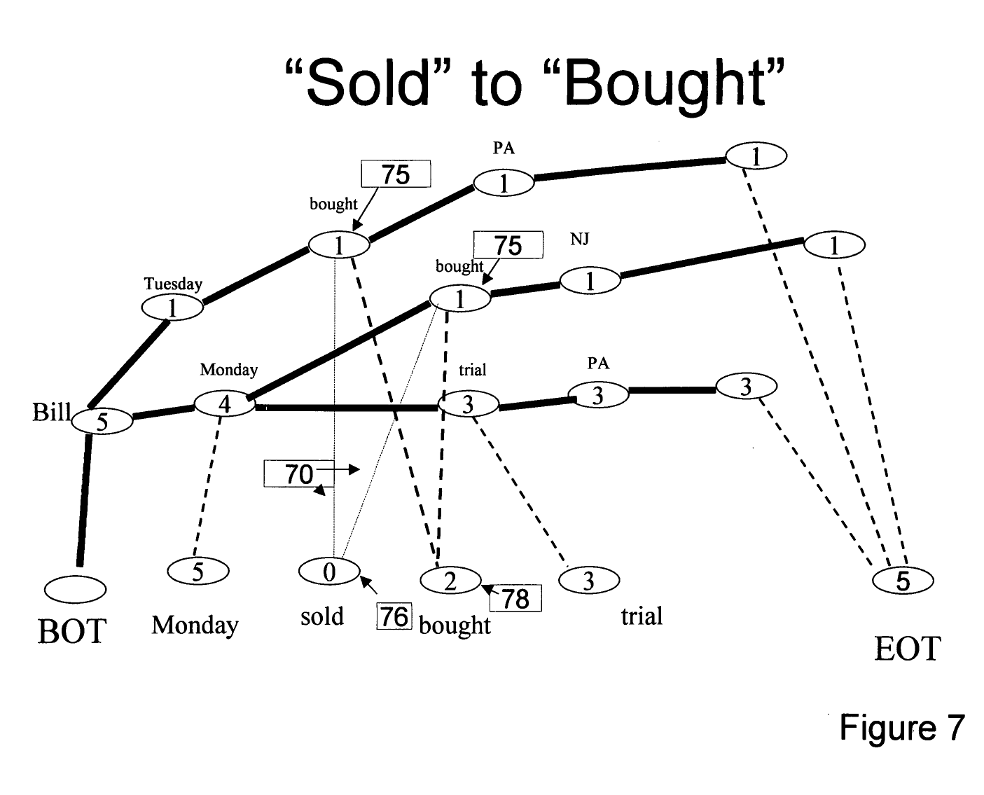

If the KStore has a field variable with a value that is invalid or incorrect in the field in which it is located and the value must be changed for all identical field variables, it would be useful to be able to so. In FIG. 7, another method for switching from one variable name to another is illustrated. Here the word “SOLD” is changed to “BOUGHT” even though it was originally, either correctly or incorrectly, received as a record indicating “SOLD”.

FIG. 7 reflects what the records might look like after the foregoing change. The pointers of the subcomponent nodes 75 are changed from the root node “SOLD” 76 to the root node “BOUGHT” 78. Thus the diagram of FIG. 7, shows the faint dotted lines 70 pointing from the subcomponent nodes “BOUGHT” to the empty root node SOLD 76 where they previously pointed. The dark dotted lines illustrate the bidirectional Result links between the root node “BOUGHT” 75 and the root node ‘BOUGHT’ 78. In this manner the occurrences of “SOLD” can be changed to “BOUGHT.” In one embodiment it is possible to remove “SOLD” and learn “BOUGHT” if it is not already present. In this embodiment, the pointers from the field end-product node for SOLD, to be eliminated are changed to the new one just introduced for BOUGHT, updating the count field 21 as appropriate.

In another case, it may only be necessary to change a sequence for a single instance and not for all instances within the structure. For example, if a record comes in for “NJ” when “PA” is intended, the single incorrect record can be changed to “PA.” In this case, the sequence for “NJ” must remain and its count altered. The sequence “PA” can then be processed for one more occurrence. If the subcomponent node at the record level contains a count of 1, the record can be changed by updating the bi-directional pointers for the PA end-product node, the NJ end-product node and the record subcomponent node. If the count is not 1, new structure must be created starting at the subcomponent node prior to the subcomponent node for NJ.

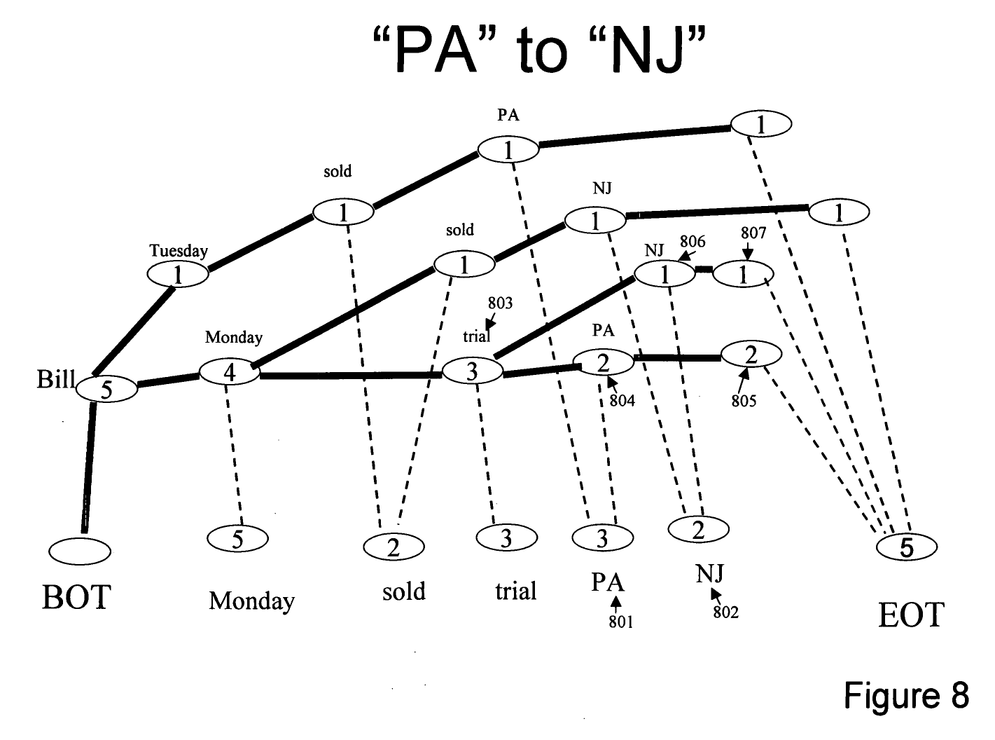

Refer to FIG. 8. Assume that one occurrence of “Bill Monday trial PA” must be changed to “Bill Monday trial NJ.” The last matching node within the selected K path, which is node 803 representing “TRIAL,” is located. The count of each subcomponent node in the path from the end-product node 805 is decremented back to but not including node 803. The new datastore structure node NJ and the end of thought node 807 are added starting after node 803 thereby indicating the end of a complete thought.

The above methods can be accomplished with the use of the facilities of a KStore system as detailed in our prior filed application U.S. patent Ser. No. 10/879,329. Various procedures within the KEngine, Utilities, or Learn Engine as taught in the foregoing references can be provided in order to store new information, or to update existing information. In addition, KStore procedures such as those taught in U.S. patent Ser. No. 10/666,382 (published as US 20050076011) can increment and decrement the count field 21 as needed. Specifically, there may be a procedure that subtracts one from a count for a field/record universe implementation.

In one embodiment, the count can be adjusted by a parameter for the “amount” or “intensity” to change. A negative value of intensity can be issued to reduce the count values in the nodes along a sequence being changed. An additional component or modification of existing components can be accomplished to eliminate nodes in those instances in which nodes do not contain count field 21 or for those cases in which count fields 21 are present by for which there exist count values of zero or other less than useful value, unless a history of previous data in the K 14a is maintained.

Thus, a method for updating a KStore includes at least one K path having at least one subcomponent node and at least one root node said at least one subcomponent node and said at least one root node containing bidirectional pointers. The method includes determining a K path representing a sequence to be altered to provide a determined K path and altering said determined K path. The altering includes altering a node of said determined K path which can be any type of node including a root node a subcomponent node. The altering can include deleting and node counts can be altered.

What is claimed is:

1. A method for updating a KStore including at least one K path having at least one subcomponent node and at least one root node said at least one subcomponent node and said at least one root node containing bidirectional pointers, comprising:
(a) determining a K path representing a sequence to be altered to provide a determined K path; and
(b) altering said determined K path.

2. The method for updating a KStore of claim 1, wherein said altering comprises altering a node of said determined K path.

3. The method for updating a KStore of claim 2, wherein said altering comprises altering a root node of said determined K path.

4. The method for updating a KStore of claim 2, wherein said altering comprises altering subcomponent node of said determined K path.

5. The method for updating a KStore of claim 1, wherein said altering comprises deleting.

6. The method for updating a KStore of claim 5, wherein said deleting comprises altering a node of said determined K path to provide an altered node.

7. The method for updating a KStore of claim 6, wherein said altered node is provided with memory allocated for storing said altered node further comprising deallocating said memory allocated for storing said altered node.

8. The method for updating a KStore of claim 7, wherein said altered node is provided with a node count further comprising altering said node count to provide an altered node count.

9. The method for updating a KStore of claim 8, wherein said altered node is provided with memory allocated for storing said altered node, further comprising:
comparing said altered node count with a predetermined value; and
deallocating said memory of said altered node in accordance with said comparing of said altered node count.

10. The method for updating a KStore of claim 2, wherein said altered node is provided with a bidirectional link further comprising altering said bidirectional link to provide an altered bidirectional link.

11. The method for updating a KStore of claim 10, wherein said altered subcomponent node is provided with a bidirectional Result link further comprising altering said bidirectional Result link to provide an altered bidirectional Result link.

12. The method for updating a KStore of claim 11, wherein said altered bidirectional Result link links said altered subcomponent node with a selected root node further comprising altering an asResult pointer list of said selected root node.

13. The method for updating a KStore of claim 11, further comprising maintaining an asResult pointer within said altered bidirectional Result link wherein said maintained asResult pointer points to said altered subcomponent node to provide a maintained asResult pointer.

14. The method for updating a KStore of claim 13, further comprising determining a history in accordance with said maintained asResult pointer.

15. The method for updating a KStore of claim 2, wherein said altered node is provided with a node count further comprising altering said node count to provide an altered node count.

16. The method for updating a KStore of claim 15, further comprising altering said node count in accordance with an intensity value to provide said altered node count.

17. The method for updating a KStore of claim 16, further comprising determining a history in accordance with said altered node count.

18. The method for updating a KStore of claim 16, further comprising determining whether said altered node count is below a predetermined value to provide an altered node count determination.

19. The method for updating a KStore of claim 18, wherein said altered node is provided with memory allocated for storing said altered node further comprising deallocating said memory in accordance with said altered node count determination.

20. The method for updating a KStore of claim 16, further comprising decrementing said node count in accordance with said intensity value.

21. The method for updating a KStore of claim 16, wherein said intensity value further comprises the value one.

22. The method for updating a KStore of claim 1, further comprising:
(a) obtaining said sequence to be altered; and
(b) particlizing said sequence to be altered to provide a particlized sequence; and
(c) determining a K location.

23. The method for updating a KStore of claim 22, further comprising determining said K path in accordance with said K location.

24. The method for updating a KStore of claim 23, wherein one of said at least one subcomponent node and said at least one root node is provided with at least one bidirectional link and said determining of said K path in accordance with said K location further comprises traversing said KStore in accordance with said at least one bidirectional link.

25. The method for updating a KStore of claim 24, wherein said bidirectional link is a bidirectional Result link further comprising traversing said KStore in accordance with said bidirectional Result link.

26. The method for updating a KStore of claim 24, wherein said bidirectional link includes a bidirectional Case link further comprising traversing said K in accordance with said bidirectional Case link.

27. The method for updating a KStore of claim 22, wherein said particlized sequence further comprises a sequence forming a portion of a K path.

28. The method for updating a KStore of claim 22, wherein said particlized sequence further determines an entire K path.

29. The method for updating a KStore of claim 28, wherein said entire K path further comprises a complete thought.

30. The method for updating a KStore of claim 1, wherein said KStore represents a plurality of paths each path of said plurality of paths having a path identification number further comprising determining said K path in accordance with a selected path identification number.

31. The method for updating a KStore of claim 30, further comprising altering in accordance with said selected path identification number.

32. The method for updating a KStore of claim 1, further comprising:
(a) obtaining a root node search value; and
(b) determining said root node in accordance with said search value.

33. The method for updating a KStore of claim 32 wherein said K includes a plurality of paths each having at least one root node further comprising:
(a) determining said root node search value within a specified root node to provide a root node specific search determination; and
(b) determining said K path in accordance with said root node specific search determination.

34. The method for updating a KStore of claim 33, further comprising altering a node of said KStore in accordance with said root node specific search determination.

35. The method for updating a KStore of claim 33, wherein said specified path has values associated the corresponding root nodes of the specified path including at least one valid value associated with the root node and at least one invalid value associated with the root node and said search value further comprises said at least one invalid value of said specified path.

36. The method for updating a KStore of claim 35, further comprising determining a number of times said invalid root node value is determined in order to provide an invalid root node value count.

37. The method for updating a KStore of claim 36, further comprising deleting said determined K path in accordance with said invalid root node value count.

38. The method for updating a KStore of claim 32, further comprising counting a number of times said K paths are determined in accordance with said search value.

39. The method for updating a KStore of claim 32, wherein said search value further comprises a sequence forming a portion of a path.

40. The method for updating a KStore of claim 1, further comprising determining a misspelling in accordance with said determined K path to provide a misspelling determination.

41. The method for updating a KStore of claim 40, further comprising correcting said misspelling.

42. The method for updating a KStore of claim 40, further comprising determining the number of times a misspelling occurs to provide a misspelling count.

43. The method for updating a KStore of claim 42, further comprising correcting said misspelling conditionally dependent upon said misspelling count.

44. The method for updating a KStore of claim 5, wherein said altering further comprises learning an updated sequence.

45. The method for updating a KStore of claim 44, further comprising said deleting prior to said learning an updated sequence.

46. The method for updating a KStore of claim-44, further comprising said learning an updated sequence prior to said deleting.

47. The method for updating a KStore of claim 1, further comprising updating a sequence wherein said altering comprises deleting a portion of said determined K path, learning an updated portion of the K path, and altering nodes of said determined K path.

48. The method for updating a KStore of claim 1, further comprising determining a history in accordance with said altering.

49. The method for updating a KStore of claim 48, further comprising indicating said history using node count values.

50. The method for updating a KStore of claim 48, further comprising storing said history external to said KStore.
